(19) United States
(12) Patent Application Publication
(10) Pub. No.: US 2024/0009762 A1
(43) Pub. Date: Jan. 11, 2024

(54) PARTITION LASER ASSEMBLING (PLA) SYSTEM AND METHOD BASED ON VECTOR GRAPHIC STRUCTURE AND OPTICAL FIELD MODULATION

(71) Applicant: NORTHWEST UNIVERSITY, Xi'an (CN)

(72) Inventors: Wei ZHAO, Xi'an (CN); Yueqiang ZHU, Xi'an (CN)

(21) Appl. No.: 18/471,433

(22) Filed: Sep. 21, 2023

Related U.S. Application Data
(63) Continuation of application No. PCT/CN2023/101695, filed on Jun. 21, 2023.

(30) Foreign Application Priority Data
Aug. 18, 2022 (CN) 202210994800.4

(51) Int. Cl. B23K 26/0622; B23K 26/38

(52) U.S. Cl. CPC B23K 26/0622; B23K 26/38

(57) ABSTRACT

A partition laser assembling based on vector graphic structure and optical field modulation includes a laser, a beam shaping-polarization modulation module, a beam modulation module, and an objective lens. The basic shape, size, and position information of a target structure are obtained by analyzing vector graphic information, and a holographic phase map of a spatial light modulator is designed. The phase map is loaded through the spatial light modulator to carry out phase modulation, so as to directly generate laser spots corresponding to basic shapes on a pupil plane of an objective lens. Then basic structures are automatically assembled on a material, realizing planar fabrication of complex structures. In combination with layer-by-layer fabrication technology, the three-dimensional fabrication of the complex structures is realized.

### CROSS-REFERENCE TO RELATED APPLICATIONS

This application is a continuation of International Patent Application No. PCT/CN2023/101695, filed on Jun. 21, 2023, which claims the benefit of priority from Chinese Patent Application No. 202210994800.4, filed on Aug. 18, 2022. The content of the aforementioned application, including any intervening amendments thereto, is incorporated herein by reference in its entirety.

### TECHNICAL FIELD

This application relates to optics and laser processing, and more particularly to a high-speed partition laser assembling (PLA) system and method based on vector graphic structure and optical field modulation.

### BACKGROUND

In the fabrication of structures using the existing laser micromachining technologies, it is required to first read in the pattern of the target structure, and then convert the pattern into the point cloud information of coordinates, and finally the coordinate point clouds to be processed are irradiated by the laser point by point to obtain the desired planar structure. Multiple planar structures are fabricated layer by layer to reach the desired three-dimensional structure.

Usually, the spot used in laser processing is a tiny point-like spot (e.g., Gaussian beam and Bessel-Gaussian beam). In the point-by-point processing, the positioning accuracy, alignment jitter, and control precision of the processing time of the laser focus will inevitably affect the uniformity and surface smoothness of the fabricated structure.

### SUMMARY

In view of the deficiencies in the prior art, this application provides a partition laser assembling (PLA) system and method based on vector graphic structure and optical field modulation.

Technical solutions of this application are described as follows.

In a first aspect, this application provides a partition laser assembling (PLA) based on vector graphic structure and optical field modulation, including:
a laser;
a beam shaping-polarization modulation module;
a beam modulation module; and
an objective lens;
wherein the laser is configured to emit a laser beam to the beam shaping-polarization modulation module;
the beam shaping-polarization modulation module is configured to perform shaping and polarization state modulation on the laser beam to generate a linearly-polarized and collimated laser beam and emit the linearly-polarized and collimated laser beam to the beam modulation module;
the beam modulation module is configured to load a series of holographic phase maps of basic shapes of a target structure in real time according to a processing flow, so as to generate a series of laser spots corresponding to the basic shapes in a vector processing path; and
the beam modulation module is also configured to emit the laser spots to a pupil plane of the objective lens; and the objective lens is configured to focus the laser spots of the basic shapes on the target structure to perform partition laser assembling of the target structure.

In an embodiment, the beam modulation module is a phase-only reflective spatial light modulator.

In an embodiment, the shaping and polarization state modulation includes spatial light filtering, beam expansion and polarization state modulation.

In an embodiment, the partition laser assembling system further includes: a first reflector;
a second reflector;
a camera;
an aperture diaphragm;
a dichroic mirror;
a translation platform; and
a control system;
wherein the beam shaping-polarization modulation module is configured to expand the laser beam to generate the linearly-polarized and collimated laser beam; and the first reflector is configured to reflect the linearly-polarized and collimated laser beam to the beam modulation module;
the aperture diaphragm and the dichroic mirror are configured such that the laser spots sequentially pass through the aperture diaphragm and the dichroic mirror to be incident at the pupil plane of the objective lens; wherein the aperture diaphragm is configured to block a zero-order spot generated by the beam modulation module; the dichroic mirror is configured to reflect the laser spots and transmit a fluorescence emitted by a photoresist; the second reflector is configured to reflect the fluorescence to the camera; and the camera is configured to observe a photoengraved structure in real time;
the translation platform is configured to spatially move the target structure; and
the control system is configured to control the beam modulation module to load the holographic phase maps in real time according to the processing flow, so as to generate a series of laser spots corresponding to basic shapes in a vector processing path.

This application further provides a partition laser assembling method by using the partition laser assembling system, including:
emitting, by the laser, a laser beam;
performing shaping and polarization state modulation on the laser beam to generate a linearly-polarized and collimated laser beam;
modulating, by the beam modulation module, the linearly-polarized and collimated laser beam by loading a series of holographic phase maps of the basic shapes of a target structure into a spatial light modulator in real time according to a processing flow, so as to generate a series of laser spots corresponding to basic shapes in a vector processing path; and
focusing the laser spots corresponding to the basic shapes to the target structure to perform partition laser assembling on the target structure.

In an embodiment, a generation of the holographic phase maps includes:
analyzing a size of a vector graphic of the target structure by resolving the vector graphic into n partitions, analyzing and resolving a structure of the vector graphic in each partition into the series of basic shapes; and
finding a corresponding basic shape for each of the n partitions by matching the vector graphic; and generating the holographic phase maps based on the basic shapes, and positions and orientations of the n partitions.

In an embodiment, the generation of the holographic phase maps further includes:
for a curve traversing two partitions of the n partitions, calculating a position of a boundary point based on a function of the curve, wherein the curve consists of a first portion located in one of the two partitions and a second portion located in the other of the two partitions; and generating a function of the first portion by taking the boundary point as an end point of the first portion in combination with a start point of the curve; and
generating a function of the second portion by taking the boundary point as a start point of the second portion in combination with an end point of the curve or another boundary point.

In an embodiment, the basic shapes include circle, ellipse, line, arc, and dot;
the holographic phase maps of the basic shapes include a phase map for circular spot, a phase map for elliptical spot, a phase map for linear spot, a phase map for arced spot, and a phase for dot-type spot;
wherein a corresponding basic shape is generated through a single holographic phase map.

In an embodiment, in the generation of the holographic phase maps of the basic shapes, the dot-type phase map is generated based on a Bessel-Gaussian beam phase;
the linear phase map is generated by adding a rotation transformation to an Airy beam;
the arced phase map is generated by combining a perfect vortex beam with a discrete phase; and
a closed-curve phase map is generated by splicing arc-shaped beam.

In an embodiment, the step of “focusing the laser spots of basic shapes to the target structure to perform partition laser assembling on the target structure” includes:
turning on the laser; loading the holographic phase maps on the beam modulation module in a time sequence and adjusting a laser energy in real time; and turning off the laser after completing fabrication of a pattern within a structure partition;
moving the target structure to a next structure partition in this layer to complete fabrication of a pattern within the next structure partition; and repeating such operations to complete fabrication of patterns in all structure partitions to realize single-layer planar fabrication; and
moving the target structure vertically; completing fabrication of patterns within individual structure partitions in a layer; and completing fabrication of patterns within individual structure partitions in all layers to realize fabrication of a three-dimensional structure.

Compared to the prior art, this application has the following beneficial effects.

Based on the combination of light field modulation technology and vector path, a complex pattern (miscellaneous spot structure, such as circles, line segments, or arcs whose shape and size can be freely defined) can be decomposed into basic shapes, and then the complex pattern is fabricated according to these basic shapes. This technology changes the previous point processing into partition laser assembling of the structure, which will greatly improve the processing efficiency, precision, uniformity, and smoothness. This application can directly fabricate the complex structure composed of basic shapes, significantly reducing the uncertainty caused by point-by-point processing, greatly improving the processing efficiency, precision, uniformity, and smoothness. Therefore, this application has a great significance in promoting the development of macro-processing and micro-processing technology.

### BRIEF DESCRIPTION OF THE DRAWINGS

FIG. 1 structurally illustrates a partition laser assembling based on vector graphic structure and optical field modulation according to one embodiment of the present disclosure;

FIG. 2 is a flow chart of vector path processing based on complex vector graphic analysis according to one embodiment of the present disclosure;

FIG. 3 a-e show simulation phase maps and light intensity distribution of five types of spots in a focusing region of an objective lens according to one embodiment of the present disclosure, where (a) a dot-type spot; (b) a linear spot; (c) an arced spot; (d) a circular spot; and (e) an elliptical spot;

FIG. 4a shows simulated light intensity distribution of a pattern fabricated by point-by-point processing;

FIG. 4b shows simulated light intensity distribution of the pattern fabricated based on combination of vector graphic structure and light field modulation;

FIG. 4c shows simulated light intensity distribution of a fingerprint structure fabricated based on the combination of vector graphic structure and light field modulation; and

FIG. 4d shows simulated light intensity distribution of a complex pattern fabricated based on the combination of vector graphic structure and light field modulation.

### DETAILED DESCRIPTION OF EMBODIMENTS

The disclosure will be described in detail below in combination with the accompanying drawings and embodiments to make the technical solutions, objects and advantages of the disclosure clearer. It should be understood that described below are merely some embodiments of the disclosure, which are not intended to limit the disclosure.

### Embodiment 1

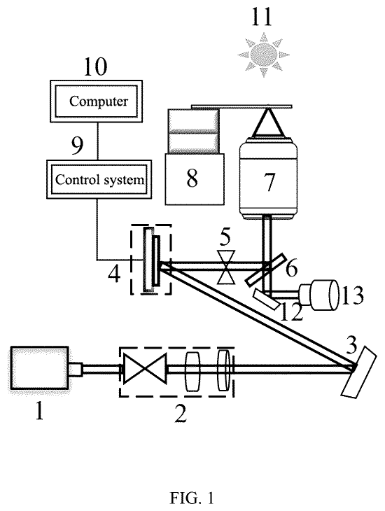

As shown in FIG. 1, a high-speed partition laser assembling system based on vector graphic structure and optical field modulation is provided, which includes a femtosecond laser (Coherent, ChameleonUltra II) 1, a beam shaping-polarization modulation module (OptoSigma, SFB-16DM) 2, a first reflector 3, a liquid crystal spatial light modulator (LETO, HOLOEYE Photonics AG, Germany, PLUTO-NIR-011, 420 nm-1100 nm) 4, an aperture diaphragm 5, a dichroic mirror 6, an objective lens (Olympus, NA1.25, 100X) 7, a translation platform (PI, E-712.6 CDA) 8, a control system 9, a computer 10, a white light source 11, a second reflector 12, and a camera 13.

The laser 1 emits a beam with the corresponding wavelength to the beam shaping-polarization modulation module 2. The beam shaping-polarization modulation module performs shaping and polarization state modulation on the beam to generate a laser beam with linear polarization and collimation and emits the laser beam with linear polarization and collimation to the beam modulation module (liquid crystal spatial light modulator) through a first reflector 3. Then, the beam modulated by the beam modulation module is incident to the pupil plane of the objective lens 7 through the dichroic mirror 6.

The beam shaping-polarization modulation module 2 performs the shaping and polarization state modulation on the beam emitted by the laser 1, such as spatial light filtering, beam expansion, and polarization state modulation.

The beam modulation module modulates the modulated beam to generate a series of laser spots according to basic shapes in sequence and emits these spots into the pupil plane of the objective lens 7 in real time. The objective lens 7 focuses these spots on the pupil plane to the target material. The beam modulation module is a reflective phase-only spatial light modulator used for real-time control of the generation of beam shapes.

The aperture diaphragm 5 is used to block the zero-order spot generated by the beam modulation module.

The reflectors are used to reflect the light beam to the phase-only spatial light modulator and the entrance pupil of the objective lens, respectively.

The translation platform 8 is used to move spatially the target structure.

The dichroic mirror 6 is used to reflect the modulated laser beam and transmit the fluorescence emitted by the photoresist.

The control system 9 is used to control the micro-nanometer translation platform to move in the appropriate area and to control the spatial light modulator to load the holographic phase maps in real time according to the processing flow, so as to generate the laser spots of basic shapes corresponding to the processing path.

A camera is used to observe the lithographic structure in real time.

### Embodiment 2

In this embodiment, a high-speed partition laser assembling method based on vector graphic structure and optical field modulation is provided. The method includes the following steps.

(S1) A laser emits a laser beam with a corresponding wavelength to the beam shaping-polarization modulation module.

(S2) The beam shaping-polarization modulation module performs shaping and polarization state modulation on the laser beam to generate a linearly-polarized and collimated laser beam. The shaping and polarization state modulation includes spatial light filtering, beam expansion, and polarization state modulation. Then, the linearly-polarized and collimated laser beam is incident to the beam modulation module through the reflector.

(S3) The linearly-polarized and collimated laser beam is modulated by the beam modulation module to generate the laser spots of basic shapes, which are reflected by the dichroic mirror to the pupil plane of the objective lens.

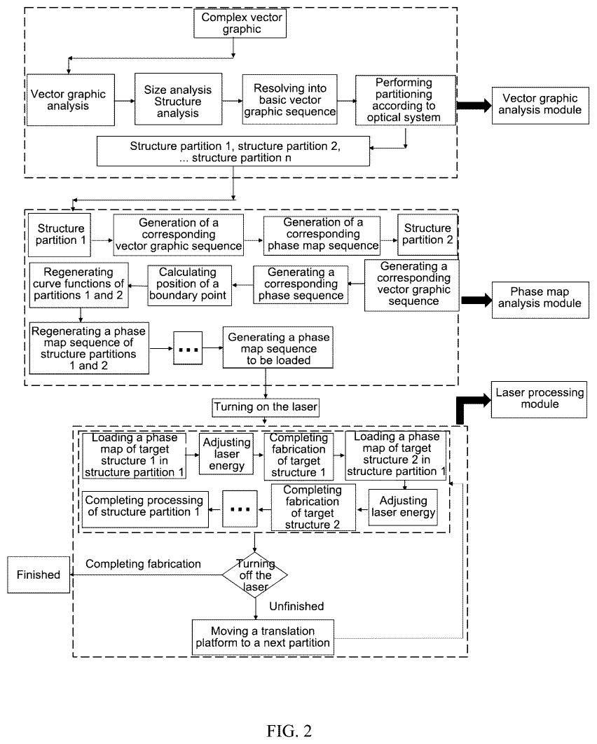

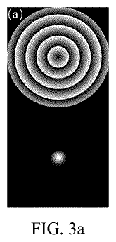

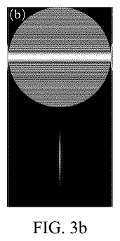

Further, referring to FIG. 2, in step (S3), the modulation of the modulated laser beam includes the following steps.

(S301) A size and a structure of a vector graphic of the target structure are analyzed.

Further, after the size is resolved, the vector graphic is partitioned according to the optical system (including parameters of the light source, objective lens, spatial light modulator), and the complex vector graphic is resolved into n partitions.

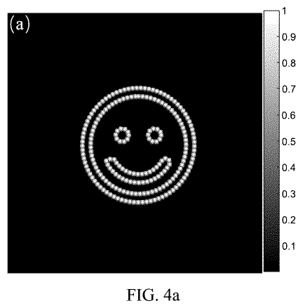

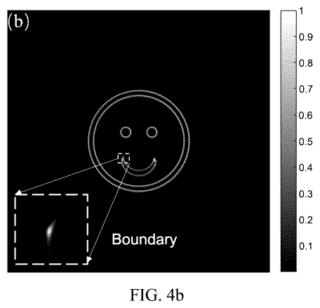

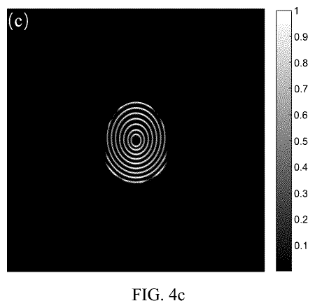

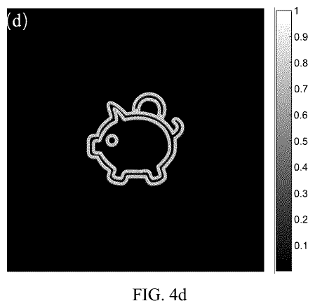

Further, the resolving structure refers to resolve the basic shapes in the vector graphic. The resolving structure is used to resolve the complex vector graphic into the basic shapes, such as circles, ellipses, straight lines, arcs, dots, etc. As shown in FIG. 4b, the resolving structure is to resolve the basic shapes in the vector graphic, and the vector graphic shown in FIG. 4b contains two basic structures, such as circular and arc-shaped structures.

(S302) A structure partition 1 in FIG. 4b is processed. For the structure partition 1, a circular shape is found by matching the vector graphic, and a corresponding holographic phase map is generated by the circular shape, position, and orientation. The basic graphic distribution of the structure partition 1 includes holographic phase maps of the basic shapes such as a phase map for circular spot, a phase map for linear spot, a phase map for arced spot, and a phase for elliptical spot. As shown in FIG. 4b, the basic graphic distribution of structure partition 1 contains the circular phase map.

(S303) Similarly, the structure partition is moved to the structure partition 2 by the translation platform. The corresponding basic shape is found by matching the vector graphic for the structure partition 2. The processing of other partitions in the complex vector graphic is the same as that in step (S302). Then the structure partition 2 is processed. The corresponding arced shape is found by matching the vector graphic for the structure partition 2. The processing of other partitions in the graphic in FIG. 4b is the same as that in step (S302). For the curve traversing the structure partition 1 and the structure partition 2, the position of a boundary point is calculated based on a function of the curve. The curve consists of a first portion located in one of the structure partition 1 and the structure partition 2 and a second portion located in the other of the structure partition 1 and the structure partition 2. A function of the first portion is generated by taking the boundary point as an end point of the first portion in combination with a start point of the curve. A function of the second portion is generated by taking the boundary point as a start point of the second portion in combination with an end point of the curve or another boundary point.

(S304) A series of phase maps of basic shapes to be loaded are generated from the structures in all the partitions. All the partitions in FIG. 4b are processed to generate a series of phase maps to be loaded.

(S305) It is judged whether these phase maps to be loaded satisfy the maximum loading amount of the hologram loading software: if satisfied, proceed to the next step; if not, the series of phase maps will be loaded in segments. After these partitions are processed, the phase maps used for subsequent partitions are loaded.

Further, in step (S303), a generation of the holographic phase map of the basic shapes includes the following steps.

(S303-1) The phase map for dot-type spot is generated based on the Bessel-Gaussian beam phase, and the phase distribution is expressed as:

φ1=exp(ikηr);
where k is a spatial frequency in vacuum; η is a radius of an axicon; and r is a radial coordinate.

(S303-2) The phase map for a line spot is obtained by adding a rotation transformation to the Airy beam, and the transformation formula is expressed as:

$$[ \begin{matrix}{k}_{x}^{′} \\ {k}_{y}^{′}\end{matrix} ] = [ \begin{matrix}0 & - 1 \\ 1 & 0\end{matrix} ] [ \begin{matrix}{k}_{x} \\ {k}_{y}\end{matrix} ]$$

where kₓ and k_{y} are the spatial frequencies; and k′ₓ and k′_{y} are the transformed spatial frequencies. The linear spot phase-only distribution is expressed as:

$${φ}_{2} ( {k}_{x} , {k}_{y} ) ∝ exp [ - a ( {k}_{x}^{′2} + {k}_{y}^{′2} ) ] exp [ i ( {k}_{x}^{′3} + {k}_{y}^{′3} ) / 3 ] ;$$

where a is an attenuation factor of an Airy beam.

(S303-3) The arced light spot is obtained as follows.

Firstly, a perfect vortex beam is generated through the phase transformation of the axicon. The desired arced light spot is attained by superimposing the discrete phases and discretizing the undesired regions.

The arced light spot with an arbitrary curvature can be obtained by changing the coordinate ratios of x and y, and the rotation matrix.

(S303-4) The closed curve can be obtained as follows.

Firstly, the arced light spots are generated based on the step S303-3. Then, these arced light spots are assembled into enclosed curves varying in size and curvature to obtain the desired closed curve.

In some embodiments, the circular phase map is generated by the perfect vortex light obtained by the axicon phase. The size of the diameter of the perfect vortex spot can be adjusted by adjusting the bottom angle of the axicon. The elliptical spot can be obtained by the perfect vortex spot by rotating the rotational matrix and can also be obtained by the arc-shaped splicing.

(S303-5) The phase map in FIG. 4b is obtained from the perfect vortex phase, and the corresponding expression is:

φ1=exp[i(lφ+ηr)];
where l is a topological charge number; φ is an azimuthal angle; η is the axicon parameter; and r is a transverse coordinate.

The arced spot shown in FIG. 4b is obtained from combining the same method of (S303-3). The arced spot with the arbitrary curvature can be obtained by changing the coordinate ratios of x and y, and the rotation matrix.

The closed curve shown in FIG. 4b can be obtained by same method of (S303-4).

(S4) The light beam modulated in the step (S3) is reflected by the dichroic mirror to the pupil plane of the objective lens and then focused by the objective lens to the target structure for processing. The target material is processed through the following steps.

(S401) The laser is turned on. The vector graphic sequence decomposed in FIG. 4b is loaded to the light field modulation software in sequence. According to the currently loaded holographic phase map, the laser energy is adjusted to complete the fabrication of one graphic. Then the next holographic phase map is loaded, and the laser energy is adjusted to complete the fabrication of the next graphic. The previous process is repeated until the fabrication of all graphics within the structure partition is completed, and the laser is turned off.

(S402) The control system moves the translation platform to the next structure partition, and the step (S401) is repeated.

(S403) Steps (S401) and (S402) are repeated to realize single-layer planar fabrication (two-dimensional processing), namely, realize the fabrication of the graphics in FIG. 4b.

(S5) The control system controls the translation platform to move vertically, and step (S4) is repeated to realize the fabrication of the three-dimensional structure.

(S6) The partition boundary can be repaired as needed by using the curve approximation method, so as to make the fabricated structure more complete, smooth and uniform.

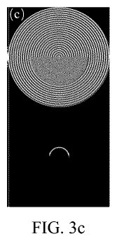

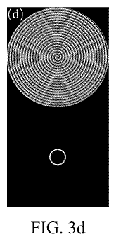

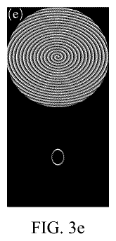

FIG. 3a-e show phase maps of the basic spots generated corresponding to the vector path of the disclosure and the corresponding light intensity distribution diagrams.

FIG. 4a shows simulated light intensity distribution of a pattern fabricated by point-by-point processing. FIG. 4b shows simulated light intensity distribution of the pattern to be fabricated based on combination of vector graphic structure and light field modulation. FIG. 4c shows simulated light intensity distribution of a fingerprint structure to be fabricated based on the combination of vector graphic structure and light field modulation. FIG. 4d shows simulated light intensity distribution of a complex pattern to be fabricated based on the combination of vector graphic structure and light field modulation.

The complex pattern can be quickly generated and fabricated through the laser spots of basic shapes. It can be obtained from the comparison between FIG. 4a and FIG. 4b that the processing efficiency of the former (point-by-point processing) is significantly lower than that of the latter (combination of vector graphic structure and light field modulation). Due to the influence of the existence of interference between the light beams, the control system cannot be accurately localized, leading to poor processing quality. Therefore, the high-speed partition laser assembling technology based on the vector graphic structure and optical field modulation significantly reduces the uncertainty caused by point-by-point processing and greatly improves the processing efficiency, precision, uniformity and smoothness. Therefore, this application has a great significance in promoting the development of macro-processing and micro-processing technology, and can be used as a prototype of the next-generation technology in the field of laser processing.

In summary, the high-speed partition laser assembling system in the disclosure obtains basic shapes, dimensions, and positional information of the target structure by analyzing vector graphic information, designs the corresponding holographic phase map of the spatial light modulator, and loads the holographic phase map through the spatial light modulator in the laser processing system to carry out the phase modulation. The laser spots of basic shapes (including but not limited to points, line segments, circles, ellipses, curves) corresponding to these basic shapes are directly generated in the focusing plane of the objective lens. Then, the basic structures are automatically performed partition laser assembling on the material, realizing planar fabrication of complex structures. Finally, combining with the layer-by-layer processing technology, three-dimensional processing of complex structures is realized, which significantly reduces the uncertainty, and greatly improves the processing efficiency, precision, uniformity, and smoothness. The method and system proposed in the disclosure can be better applied to industrial manufacturing, micro-nano manufacturing, material manufacturing and other fields.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A partition laser assembling (PLA) system based on vector graphic structure and optical field modulation, comprising:
a laser;
a beam shaping-polarization modulation module;
a beam modulation module; and
an objective lens;
wherein the laser is configured to emit a laser beam to the beam shaping-polarization modulation module;
the beam shaping-polarization modulation module is configured to perform shaping and polarization state modulation on the laser beam to generate a linearly-polarized and collimated laser beam and emit the linearly-polarized and collimated laser beam to the beam modulation module;
the beam modulation module is configured to load a series of holographic phase maps of basic shapes of a target structure on the beam modulation module to modulate the linearly-polarized and collimated laser beam in real time according to a processing flow, so as to generate a series of laser spots corresponding to the basic shapes in a vector processing path; and
the beam modulation module is also configured to emit the series of laser spots to a pupil plane of the objective lens; and the objective lens is configured to focus the series of laser spots on the target structure to perform partition laser assembling of the target structure.

2. The partition laser assembling system of claim 1, wherein the beam modulation module is a phase-only reflective spatial light modulator.

3. The partition laser assembling system of claim 1, wherein the shaping and polarization state modulation comprises spatial light filtering, beam expansion and polarization state modulation.

4. The partition laser assembling system of claim 1, further comprising:
a first reflector;
a second reflector;
a camera;
an aperture diaphragm;
a dichroic mirror;
a translation platform; and
a control system;
wherein the beam shaping-polarization modulation module is configured to expand the laser beam to generate the linearly-polarized and collimated laser beam; and the first reflector is configured to reflect the linearly-polarized and collimated laser beam to the beam modulation module;
the aperture diaphragm and the dichroic mirror are configured such that the series of laser spots sequentially pass through the aperture diaphragm and the dichroic mirror to be incident at the pupil plane of the objective lens; wherein the aperture diaphragm is configured to block a zero-order spot generated by the beam modulation module; the dichroic mirror is configured to reflect the series of laser spots and transmit a fluorescence emitted by a photoresist; the second reflector is configured to reflect the fluorescence to the camera; and the camera is configured to observe a photoengraved structure in real time;
the translation platform is configured to spatially move the target structure; and
the control system is configured to control the beam modulation module to load the holographic phase maps in real time according to the processing flow, so as to generate the series of laser spots corresponding to the basic shapes in the vector processing path.

5. A partition laser assembling method by using the partition laser assembling system of claim 1, comprising:
emitting, by the laser, a laser beam;
performing shaping and polarization state modulation on the laser beam to generate a linearly-polarized and collimated laser beam;
modulating, by the beam modulation module, the linearly-polarized and collimated laser beam by loading a series of holographic phase maps of basic shapes of a target structure in real time according to a processing flow, so as to generate a series of laser spots corresponding to the basic shapes in a vector processing path; and
focusing the series of laser spots to the target structure to perform partition laser assembling on the target structure.

6. The partition laser assembling method of claim 5, wherein a generation of the holographic phase maps comprises:
analyzing a size of a vector graphic of the target structure by resolving the vector graphic into n partitions, and analyzing a structure of the vector graphic by resolving the vector graphic into the basic shapes; and
finding a corresponding basic shape for each of the n partitions by matching the vector graphic; and generating the series of holographic phase maps based on the basic shapes, and positions and orientations of the n partitions.

7. The partition laser assembling method of claim 6, wherein the generation of the series of holographic phase maps further comprises:
for a curve traversing two partitions of the n partitions, calculating a position of a boundary point based on a function of the curve, wherein the curve consists of a first portion located in one of the two partitions and a second portion located in the other of the two partitions; and generating a function of the first portion by taking the boundary point as an end point of the first portion in combination with a start point of the curve; and
generating a function of the second portion by taking the boundary point as a start point of the second portion in combination with an end point of the curve or another boundary point.

8. The partition laser assembling method of claim 6, wherein the basic shapes comprise circle, ellipse, line, arc, and dot;
the series of holographic phase maps of the basic shapes comprise a phase map for circular spot, a phase map for elliptical spot, a phase map for linear spot, a phase map for arced spot, and a phase map for dot-type spot;
wherein a basic shape is generated through a single holographic phase map corresponding to the basic shape.

9. The partition laser assembling method of claim 8, wherein in the generation of the series of holographic phase maps of the basic shapes, the phase map for dot-type spot is generated based on a Bessel-Gaussian beam phase;
the phase map for linear spot is generated by adding a rotation transformation to an Airy disc;
the phase map for arced spot is generated through the following steps:
generating a perfect vortex beam phase map through phase transformation of an axicon; and
superimposing the perfect vortex beam phase map with a discrete phase, and discretizing undesired regions to attain the phase map for arced spot; and
a closed-curve spot phase map is generated through the following steps:
generating a plurality of phase maps for arced spot; and
assembling the plurality of phase maps for arced spot into enclosed curves varying in size and curvature to obtain the phase map for the closed-curve spot.

10. The partition laser assembling method of claim 5, wherein the step of “focusing the series of laser spots to the target structure to perform the partition laser assembling on the target structure” comprises:
turning on the laser; loading the series of holographic phase maps on the beam modulation module in a time sequence and adjusting a laser energy in real time; and turning off the laser after completing fabrication of a pattern within a structure partition;
moving the target structure horizontally to a next structure partition to complete fabrication of a pattern within the next structure partition; and repeating such operations to complete fabrication of patterns in all structure partitions to realize single-layer planar fabrication; and
moving the target structure vertically; completing fabrication of patterns within individual structure partitions in a layer; and completing fabrication of patterns within individual structure partitions in all layers to realize fabrication of a three-dimensional structure.
